(19) United States
(12) Patent Application Publication
(10) Pub. No.: US 2020/0327125 A1
(43) Pub. Date: Oct. 15, 2020

(54) SYSTEMS AND METHODS FOR HIERARCHICAL PROCESS MINING

(71) Applicant: Minit j.s.a., Bratislava (SK)

(72) Inventors: Michal ROSIK, Bratislava - Stare Mesto (SK); Jaroslav ZUBAK, Bratislava - Ruzinov (SK); Rastislav HLAVAC, Bratislava - Ruzinov (SK)

(21) Appl. No.: 16/846,241

(22) Filed: Apr. 10, 2020

Related U.S. Application Data
(60) Provisional application No. 62/832,788, filed on Apr. 11, 2019.

(51) Int. Cl. G06F 16/2458; G06K 9/62; G06F 11/34; G06F 17/15

(52) U.S. Cl. CPC G06F 16/2465; G06K 9/6219; G06F 2201/835; G06F 11/3476; G06F 17/15; G06K 9/6262

(57) ABSTRACT

Systems and methods for hierarchical process mining are disclosed. In one embodiment, in an information processing apparatus comprising at least one compute processor, a method for hierarchical process mining may include: (1) collecting, from a data source, data comprising a plurality of attributes; (2) correlating the data; (3) creating a hierarchy of the correlated data by clustering the correlated data; (4) validating the hierarchy by verifying that each sub-value in the hierarchy fits into a higher level of the hierarchy; (5) processing the corelated data with a process mining algorithm to identify a process model; (6) combining the validated hierarchy with the identified process model; and (7) graphically presenting the hierarchy in an interactive manner, wherein the hierarchy may be interacted with by moving up or down in the hierarchy.

### RELATED APPLICATIONS

This application claims the benefit of, and priority to, U.S. Provisional Patent Application Ser. No 62/832,788, filed Apr. 11, 2019, the disclosure of which is hereby incorporated, by reference, in its entirety.

### BACKGROUND OF THE INVENTION

### 1. Field of the Invention

Embodiments are generally directed to systems and methods for hierarchical process mining.

### 2. Description of the Related Art

Process mining is a set of techniques to discover, monitor and improve real processes by extracting knowledge from event logs readily available in today's information systems. Process mining provides an important bridge between data mining and business process modeling and analysis.

### SUMMARY OF THE INVENTION

Systems and methods for hierarchical process mining are disclosed. In one embodiment, in an information processing apparatus comprising at least one compute processor, a method for hierarchical process mining may include: (1) collecting, from a data source, data comprising a plurality of attributes; (2) correlating the data; (3) creating a hierarchy of the correlated data by clustering the correlated data; (4) validating the hierarchy by verifying that each sub-value in the hierarchy fits into a higher level of the hierarchy; (5) processing the corelated data with a process mining algorithm to identify a process model; (6) combining the validated hierarchy with the identified process model; and (7) graphically presenting the hierarchy in an interactive manner, wherein the hierarchy may be interacted with by moving up or down in the hierarchy.

In one embodiment, the data may include a data log, and each column in the data log may include an attribute.

In one embodiment, each attribute may be a level in the hierarchy.

In one embodiment, the data may be received as a plurality of data structures that may be linked by a correlation indicator or foreign key.

In one embodiment, the data may be received from an event log merge.

In one embodiment, the data may be correlated using a data correlation algorithm, a timestamp, a process or event identifier, a human or a system resource, etc.

In one embodiment, the data may be correlated based on an application.

According to another embodiment, a system for hierarchical process mining may include a plurality of data sources; a user electronic device comprising a display; and a server comprising at least one computer processor. A computer program or application executed by the server may perform the following: (1) collects data comprising a plurality of attributes from the plurality of data sources; (2) correlates the data; (3) creates a hierarchy of the correlated data by clustering the correlated data; (4) validates the hierarchy by verifying that each sub-value in the hierarchy fits into a higher level of the hierarchy; (5) processes the corelated data with a process mining algorithm to identify a process model; (6) combines the validated hierarchy with the identified process model; and (7) graphically presents the hierarchy on the display in an interactive manner, wherein the hierarchy may be interacted with by moving up or down in the hierarchy.

In one embodiment, the data may include a data log, and each column in the data log may include an attribute.

In one embodiment, each attribute may be a level in the hierarchy.

In one embodiment, the data may be received as a plurality of data structures that are linked by a correlation indicator or foreign key.

In one embodiment, the data may be received from an event log merge.

In one embodiment, the data may be correlated using a data correlation algorithm, a timestamp, a process or event identifier, a system resource, an application, etc.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts a system for hierarchical process mining according to one embodiment;

FIG. 2 depicts a method for hierarchical process mining according to one embodiment;

FIG. 3A depicts a schematic diagram of clustering according to embodiments;

FIG. 3B illustrates cluster expansion and collapse according to embodiments;

FIG. 4 depicts a general view of inputs and outputs according to one embodiment;

FIG. 5 depicts a process map with a closed hierarchy is disclosed according to one embodiment;

FIG. 6 depicts a process map with a partially-closed hierarchy is disclosed according to one embodiment;

FIG. 7 depicts a process map with an expanded hierarchy is disclosed according to one embodiment;

FIG. 8 depicts a process map with expanded hierarchy details is disclosed according to one embodiment; and

FIG. 9 depicts an exemplary business process management (BPM) view hierarchy according to one embodiment.

### DETAILED DESCRIPTION OF PREFERRED EMBODIMENTS

Systems and methods for hierarchical process mining are disclosed.

Hierarchical process mining introduces the concept of multilayered event logs, where each event is a part of event log hierarchy, and is also a part of hierarchy inside its own event log. For example, a process may have the following structure:

Process 1
Sub-process 1
   Task 1.1
      Activity A
      Activity B
   Task 1.2
   Task 1.3
Sub-process 2

In this example, Activity A is part of a hierarchy Process 1/Subprocess 1/Task 1.1 in this event log/dataset. Subprocess 1 may, as an excerpt of this dataset, become part (e.g., in a form of Task) of a hierarchy in a different event log.

In embodiments, an analyst may change the event log granularity based on the levels identified in the dataset, and may look at the process on the level of individual activities. The analyst may also go one level higher and look at it from the viewpoint of tasks. Thus, the analyst has the ability to expand the activity detail for a particular task. For example, the analyst may view the activity at the individual level, application level, script level, or bot level. The analyst may also see different statistical information and metrics calculated as aggregates for the individual hierarchies based on their content.

A non-limiting example is as follows. Activity A and Activity B are both members of higher hierarchical entity Task 1.1, and Activity A, Activity B, Task 1.1, Task 1.2 and Task 1.3 are members of higher hierarchy Sub-process 1.

The individual levels in the hierarchy may be automatically identified by hierarchy process mining algorithms, by a manual process, or by a combination of the two. In one embodiment, machine learning may be used to automate the manual process.

The building of a hierarchical process allows for process “drill down,” expanding an encapsulated layer into more detailed process model.

Embodiments may provide at least some of the following technical advantages: (1) seamless process model simplification by moving to higher process layers; (2) seamless process model simplification by collapsible hierarchical clusters (clusters encapsulated in other clusters); and (3) the identification of hidden sub-processes inside complex processes.

Embodiments may be used with robotic process automation (“RPA”), where event logs (e.g., from a UI recorder, software robot execution, etc.) may be considered to be fundamentally hierarchical. Embodiments may be used in a RPA candidate identification phase, where business process models may be combined with user interface (“UI”) recorder process models. Embodiments may also be used in the monitoring phase, where the business process models may be combined with data from running bots in order to see the complete end-to-end process.

In one embodiment, business process models (e.g., higher level) may be discovered from business information systems (such as customer relationship management (“CRM”) systems, Enterprise Resource Planning (“ERP”) systems, event logs, etc.), and may be combined with finely granular UI recorder process models using, for example, timestamps (i.e., the date and time when the individual event occurred), human or system resources, other attributes, etc. into a single log.

A higher level hierarchical view permits the use of pattern recognition algorithms to identify repetitive manual tasks (with noise) that may be ideal for RPA implementation, as pattern recognition on a higher level of granularity reduces noise of the UI recording.

In one embodiment, automated actions may be taken based on the analysis. For example, actions to address areas of concern in the process (e.g., choke points, slowness, faults, etc.) may be taken. Automated remedial actions (e.g., process redesign, bot modification, additional training, alerts and/or notifications, etc.) may also be taken.

Example uses cases include RPA (e.g., UI recording (such as application, window, form, field, etc.), bot execution, etc.); organizational mining (e.g., organizational structure (organization, country/region, organizational unit, division, department, team, individual, etc.); source code structure (e.g., solution, project, class, method, etc.). Embodiments have applicability to other use cases, and this list is not limiting.

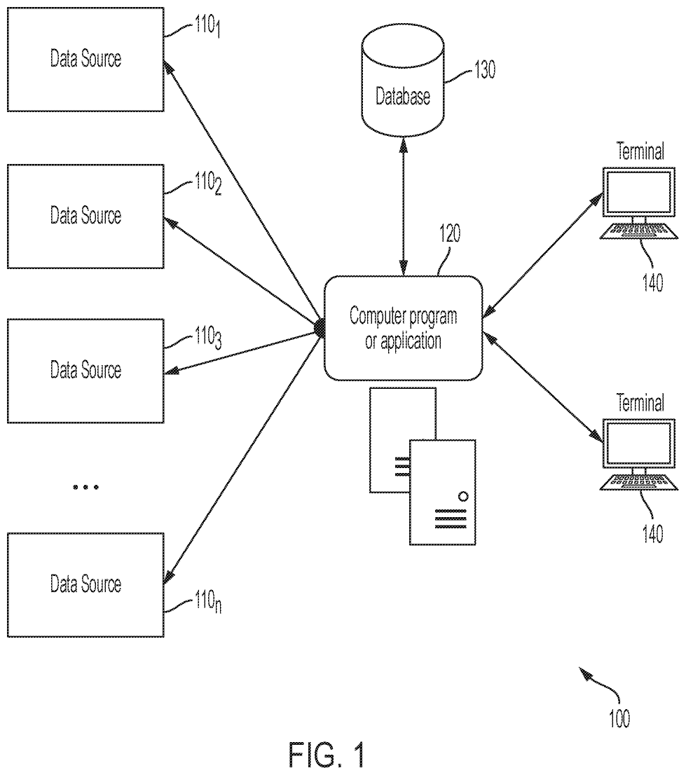

Referring to FIG. 1, a system for hierarchical process mining is disclosed according to one embodiment. System 100 may include, for example, one or more data source 110, which may be any suitable source of data, such as an organization hierarchy or chart, organization systems such as SAP, Salesforce, ServiceNow, Oracle EBS, Microsoft Dynamics 365, etc., processes, software, business process traces in information systems, software, audit logs and other event logs produced by software or devices, devices, user interfaces, user interface recorders, etc.

Computer program or application 120 may collect data from data sources 110, and may process the data. For example, computer program or application 120 may collect and process the data to identify a hierarchy, and may further associate actions with the hierarchy. It may combine the data sources (e.g., event logs having different granularity levels) that do not have common unique identifiers with other data sources or event logs based on the correlation between the human or system resource with a timestamp (e.g., date and time) or other attributes. Based on these and other parameters, relevant excerpts of the event logs with low granularity may be taken and inserted into event logs with a higher granularity to form a hierarchy level out of the event log with low granularity and combined to provide the ability to explore, or “drill-down” into the hierarchy.

In one embodiment, machine learning techniques may be used by computer program or application 120 to correlate the different granularity logs and may be used to identify the hierarchy.

In one embodiment, computer program or application 120 may be executed by one or more computer system (e.g., servers), in the cloud, etc.

One or more terminal 140 may provide access to the processed data. In one embodiment, an analyst may view the data, and may further analyze the data at different levels in the hierarchy.

In one embodiment, computer program or application 120 may execute pattern recognition algorithms with or on top of hierarchical process models/maps; thus, patterns which, at a high level of granularity, have significant noise, may be categorized as similar or related to one pattern. Selecting the right variant of the resulting process model, or its part may be used to generate a software bot.

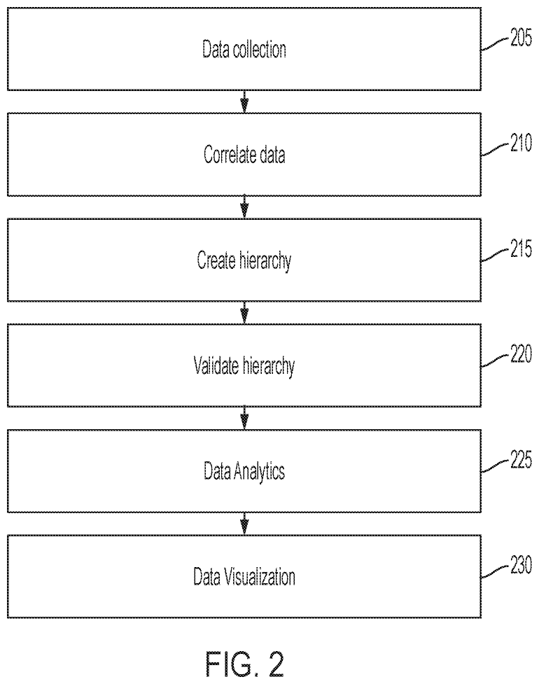

Referring to FIG. 2, a method for hierarchical process mining is disclosed according to one embodiment. In step 205, data may be collected. In one embodiment, the data may be collected from one or more data source as, for example, one or more attributes. For example, an event log may include several columns, such as a first column for the organization, a second column for a region, a third column for a division, a fourth column for a department, etc. The columns form a hierarchy, and each activity in the event log fits into several levels of the hierarchy such as: ORG/Europe/Slovakia/Finance/Financial Audit. This way it is possible to drill down and see, for example, aggregated statistics per region (e.g., Europe), and if it is interesting for the analysis, to expand the hierarchy to see countries and their aggregations.

The event log attributes may have different granularity levels. For example, an algorithm may be used to check all attributes in the eventlog and evaluate them as suitable or not suitable for clustering, i.e., whether they might be part of hierarchy.

In one embodiment, data may be collected by recognizing the data in an event log and master data. These may be separate database structures, and a correlation identifier or foreign key may be provided to link or associate the event log to the master data structure. An example of such is the structure of an organization and event in an event log referencing a particular element in the organization.

In one embodiment, data may be received from an event log merge. For example, a high-level event log (e.g., from Line of Business (LOB) information systems such as SAP, Salesforce, etc.) may be combined with low event logs (e.g., user interface interaction recordings). The event logs may provide different granularity.

In one embodiment, the attributes may be automatically recognized, or they may be recognized semi-automatically. For example, with automatic recognition of attributes (i.e., clustering attributes), each hierarchy level may be required to fulfil clustering attribute conditions, such as each value low granularly attribute must have only a single value of clustering attribute (higher granularity attribute). In other words, elements of a lower hierarchy must fit into one element of the higher hierarchy level.

A hierarchical view permits the use of pattern recognition algorithms to identify repetitive manual tasks (with noise) that may be ideal for RPA implementation, as pattern recognition on a higher level of granularity reduces noise of the UI recording.

In one embodiment, the attributes may be recognized semi-automatically. For example, a user may manually add a hierarchy level, and may select activities, clusters, etc. and may define them as part of a cluster.

In step 210, the collected data may be correlated. In one embodiment, one or more data correlation algorithm may be applied to the collected data. For example, for collected data that does not have a common unique identifier, it may be based on the correlation between the human or system resource (e.g., any system or system module executing an activity, an application, etc.) may be combined with a timestamp (e.g., a date and time that the activity was executed). Based on these and other parameters, relevant excerpts of the event logs may be taken with a higher granularity, and combined into the hierarchical process model the ability to explore, or “drill-down” into the hierarchy. Other filtering and correlation algorithms and methods may be used. Machine learning algorithms may be used as is necessary and/or desired.

In one embodiment, a correlation of a high-level event log and low-level event log may be determined based on, for example, (a) a case identifier (e.g., any suitable identifier for the event or a process thereof), (b) the user, (c) the timespan (e.g., the length of the event), (d) the organizational structure, and (e) the applications (blacklisted or whitelisted applications where process traces are left, having a correlation key in high-level event log). An example of such is the robotic process automation (RPA)-UI recording event log (low-level) combined with the event-log from information systems such as SAP, Salesforce, etc. (high-level). In this case, high-level event log is investigated and excerpts from the low-level event log are taken based on above mentioned attributes that fit into the timespan of the high-level activities. For example, for the activity “Fill in Purchase Order form” in high-level event log lasting 30 minutes, an excerpt of the same 30 minutes is found in the low-level event log for the same user, taking into account his interaction with just whitelisted applications and this excerpt is inserted into high-level event log. Thus, if the user expands the above-mentioned activity as hierarchy level, the user will see the level of applications, and if expanded further, the user will see the level of interactions such as typing, pressing buttons or clicking.

In another embodiment, correlation may be determined by (a) timespan (e.g., the length of the event), and (b) the case identifier (e.g., as an input parameter to the RPA robot). An example is a RPA-bot monitoring event log (low-level) combined with the event-log from information systems such as SAP, Salesforce, etc. (high-level). In this case, excerpts from the low-level event log are taken based on above mentioned attributes by identifying those bot executions that fit into the high-level activities. For example, for the activity “Fill in Purchase Order form” in high-level event log excerpt of bot executing this activity is found in the low-level event log and this excerpt is inserted into high-level event log. Thus, if the user expands the above-mentioned activity as hierarchy level, the user will see the execution of the bot.

In another embodiment, correlation may be determined using (a) the case identifier, (b) the timespan (e.g., the length of the event), and (c) user information. An example of it is combining event log of higher level process with event log of sub-processes (low-level) executed as part of this higher-level process. In this case, excerpts or the whole from the low-level event log are taken based on above mentioned attributes by identifying those sub-processes that fit into the high-level activities. For example, for the activity “Check contract existence” in high-level event log excerpt of several steps of sub-processes in several departments such as Legal, Archive etc. is found in the low-level event log and this excerpt is inserted into high-level event log. Thus, if the user expands the above-mentioned activity as hierarchy level, the user will see the sub-process activities. In one embodiment, sub-process activities may or may not be a part of the subsequent hierarchy.

Other techniques for correlating data may be used as is necessary and/or desired.

Next, the data may be analyzed. In one embodiment, this may include the creation of a hierarchy in step 215, and the validation of the hierarchy in step 220. The hierarchy may be created automatically or manually, and may include the identification of hierarchy attributes. In one embodiment, possible clustering attributes may be automatically identified in the combined event log based on the conditions described above. The order of levels of hierarchy (identified clustering attributes) may be identified based on primary metrics (e.g., a count of unique values in a specific level) and secondary metrics (e.g., a count of rows with empty cells in a specific level). Because the correct order of levels with the same value of primary and secondary metric may not be assigned, manual intervention may be needed to form complete hierarchy.

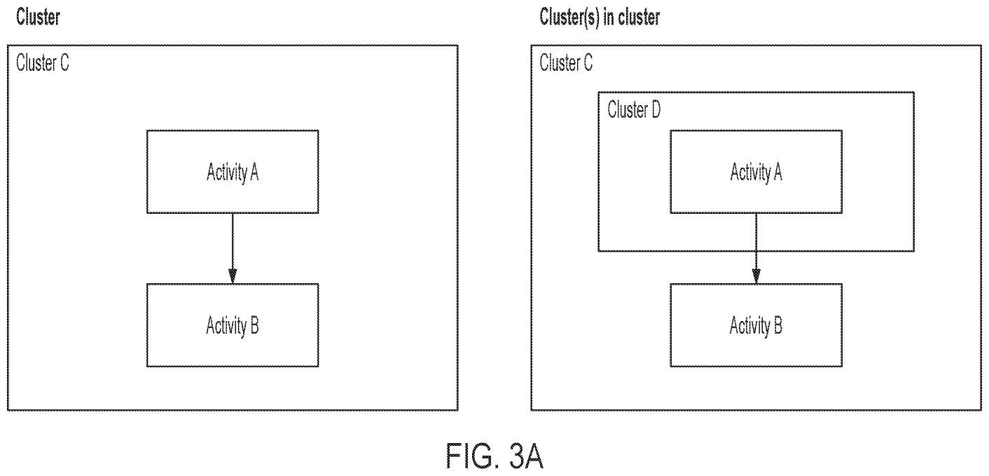

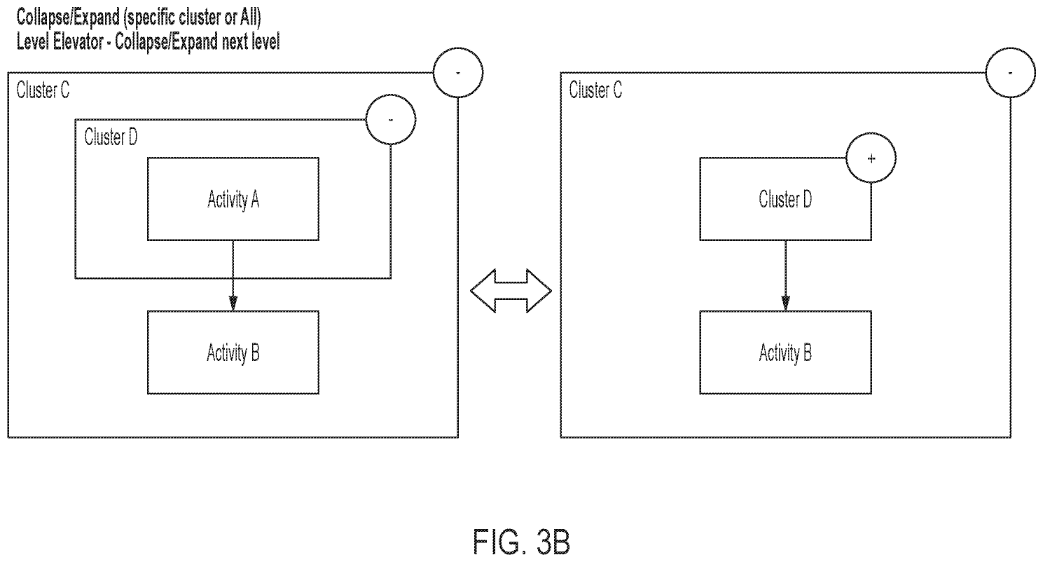

Referring to FIG. 3A, a schematic diagram of clustering is provided according to embodiments. The left side depicts a single level hierarchy with activities A and B in single cluster C, and the right side depicts a two-level hierarchy with activity A in cluster D and both activity B and cluster D encapsulated in cluster C, thus forming hierarchy C/D.

FIG. 3B depicts a fully expanded hierarchy with both clusters C and D expanded (d) partially expanded hierarchy with cluster D collapsed and cluster C expanded (e) note that collapsed cluster resembles (looks like) an activity showing aggregated statistics/metrics for all elements included in the cluster.

Referring again to FIG. 2, in step 220, the hierarchy may be validated to ensure that it suits the collected data and is valid for visualization. For example, moving up the hierarchy, the system may verify that the same value from a sub-hierarchy fits into a single higher level in the hierarchy. There must not be empty values in the middle level of the hierarchy.

In step 225, data analytics may be performed. For example, the eventlog may be processed with a process mining algorithm to get the process map/process model. The validated hierarchy may be combined with the process model to fit the model into the hierarchy. Every time the model is recalculated, the hierarchy may be recalculated as well using the process mining algorithm running on top of the eventlog and the hierarchy.

In one embodiment, when a part of the hierarchy is collapsed, the collapsed hierarchy level/part may be considered as an activity on the hierarchy level which is the lowest one to be expanded. As an example, if cluster D containing activity A and B is collapsed, it is considered by the process management algorithm as virtual activity D (all path/edges leading to or from activities A and B are considered leading to virtual activity D), and the process mining algorithm may run on top of the dataset, where all activities A and B have been virtually replaced by D.

In one embodiment, the data analysis may identify areas of concern (e.g., choke points, slowness, faults, etc.).

In step 230, the data may be visualized for the user. In one embodiment, the hierarchy may be displayed at one level. The level may be the top level, the bottom level, any middle level, or a combination thereof. The user may select an element in the hierarchy, and may be able to navigate to a higher level, or the lower level as desired.

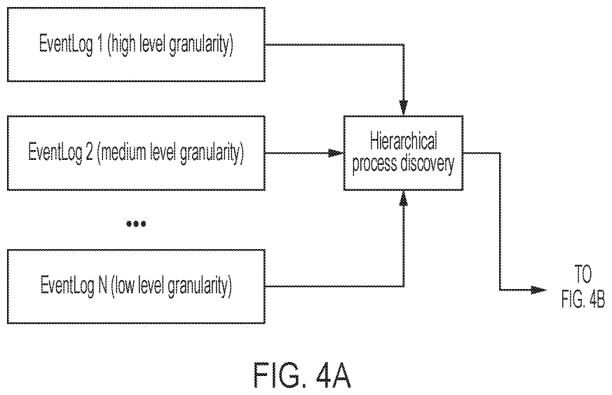

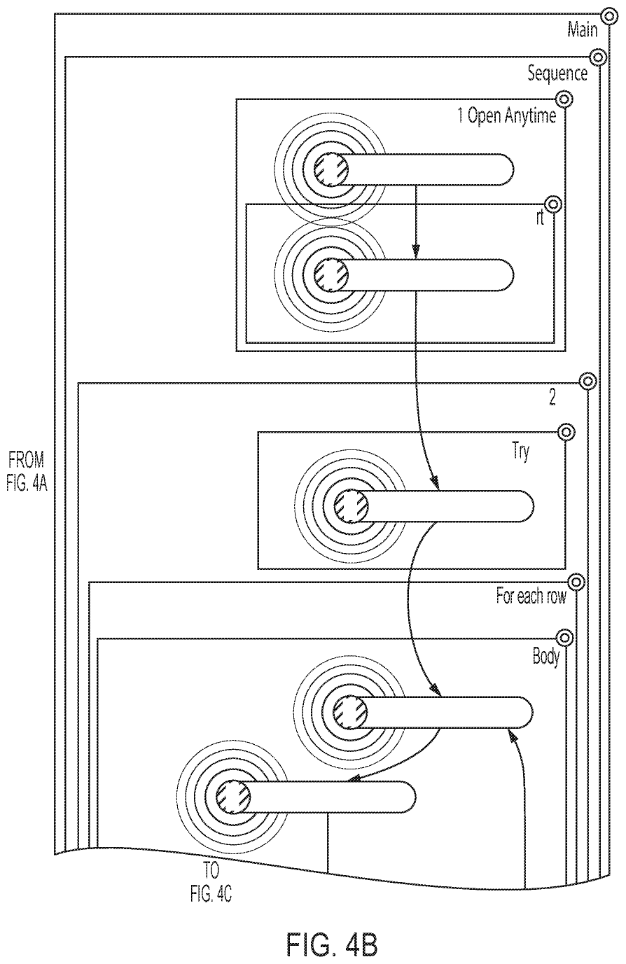

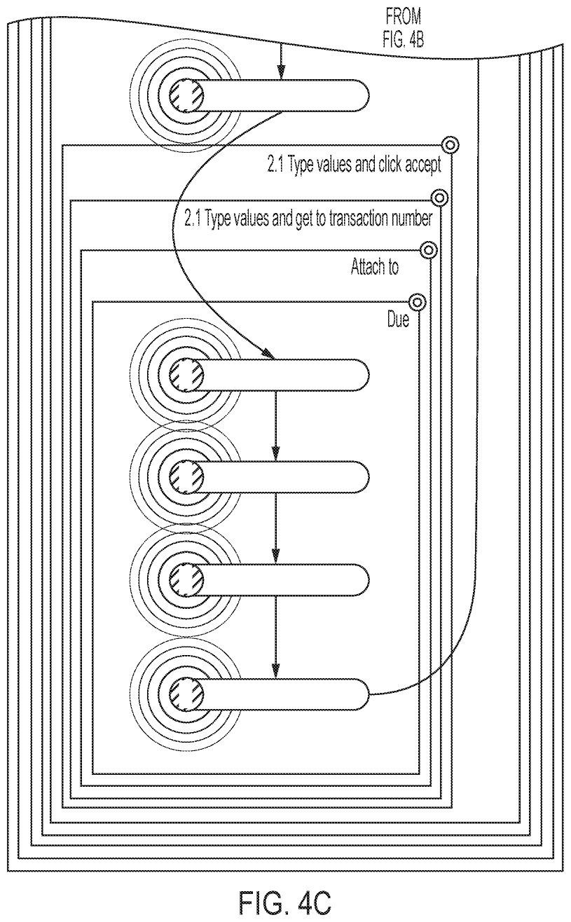

FIG. 4 depicts a general view of inputs and outputs according to one embodiment. For example, the left side of FIG. 4 depicts inputs (e.g., eventlogs having varying degrees of granularity), a hierarchical process discovery, and the graphical output of the hierarchy.

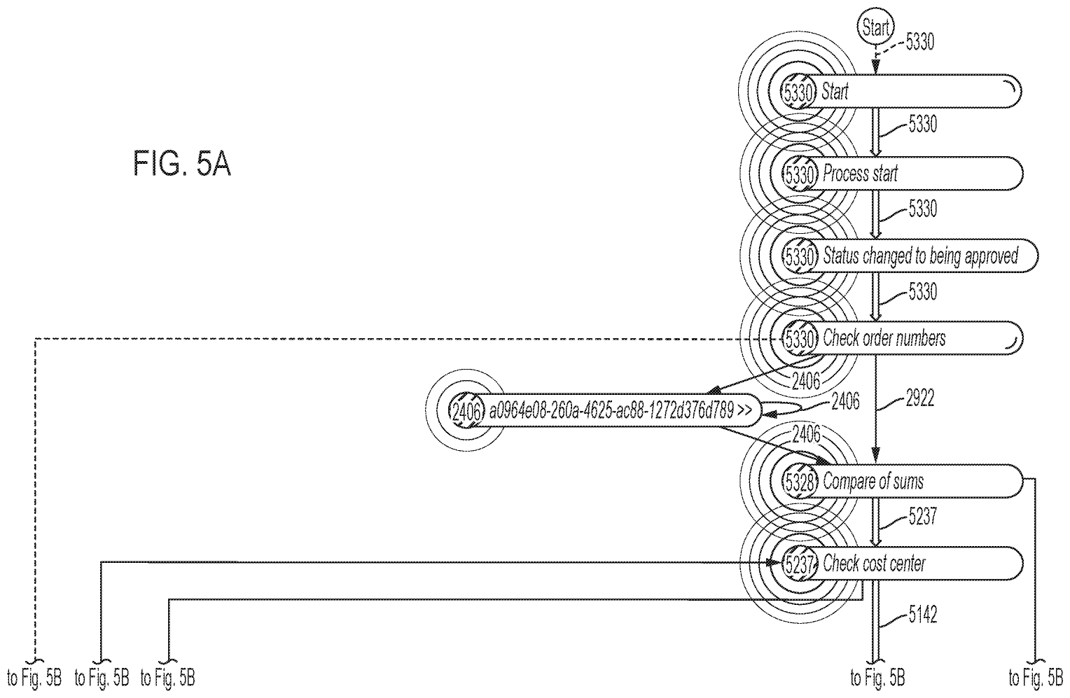

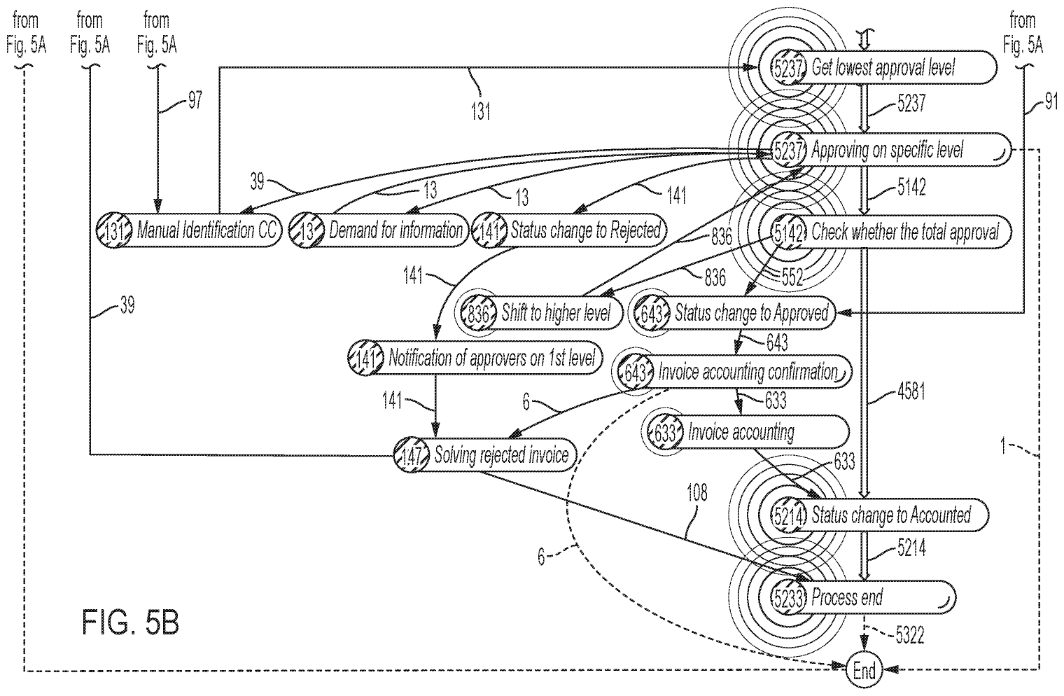

Referring to FIG. 5, a process map with a closed hierarchy is disclosed according to one embodiment. FIG. 5 depicts the hierarchical part of a high granularity eventlog that is inserted into a low granularity business process model with the hierarchy collapsed. Thus, this illustrates a high-level process, or low granularity, view.

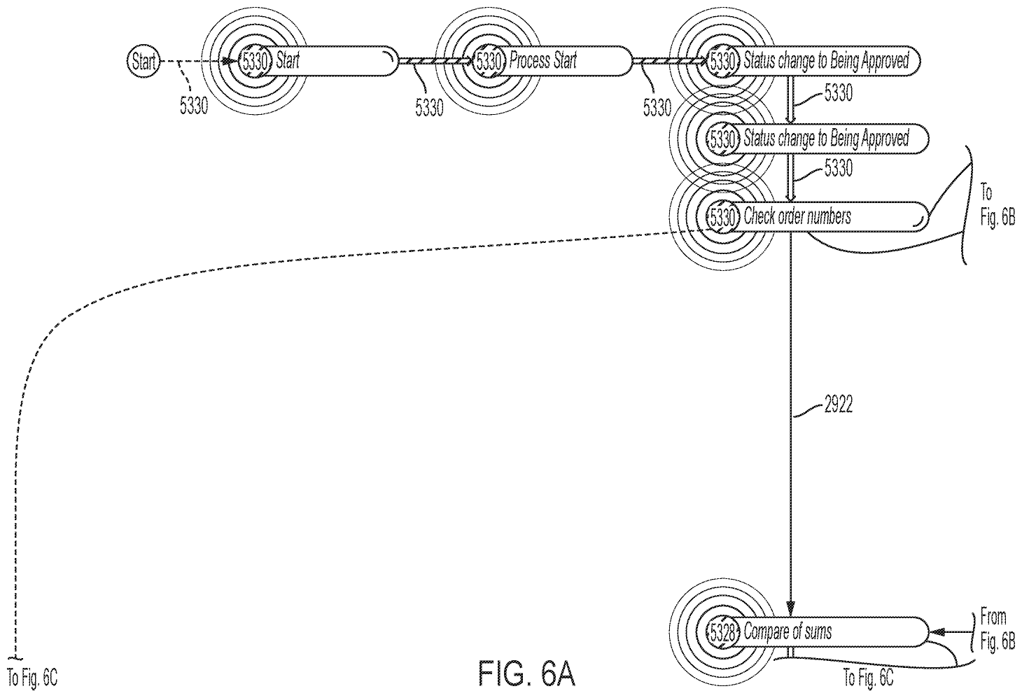

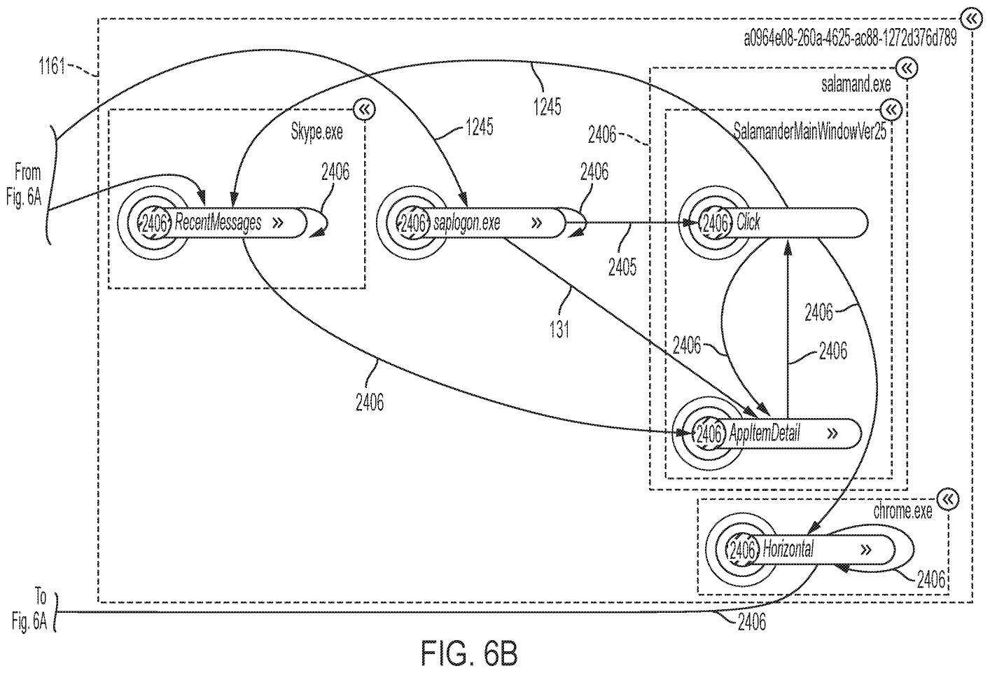

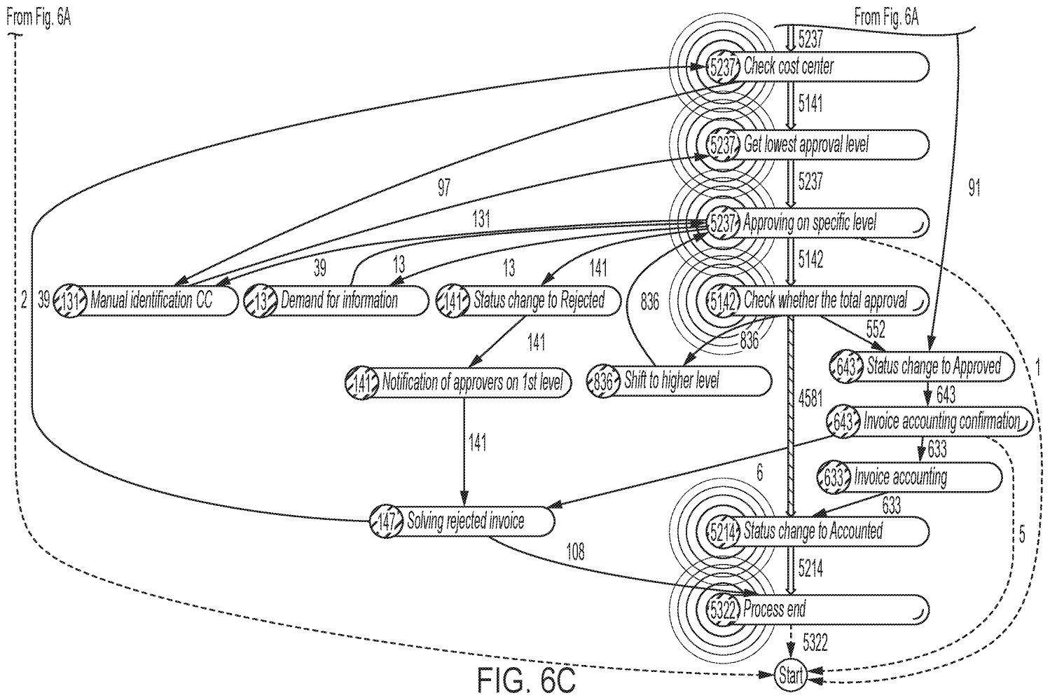

Referring to FIG. 6, a process map with a partially-closed hierarchy is disclosed according to one embodiment. For example, FIG. 6 illustrates the hierarchical part of a high granularity eventlog inserted into a low granularity business process model with the several parts of the hierarchy expanded to different levels (e.g., a “drill-down”). Thus, this illustrates a multi-level process view with combined low and high granularity in certain parts.

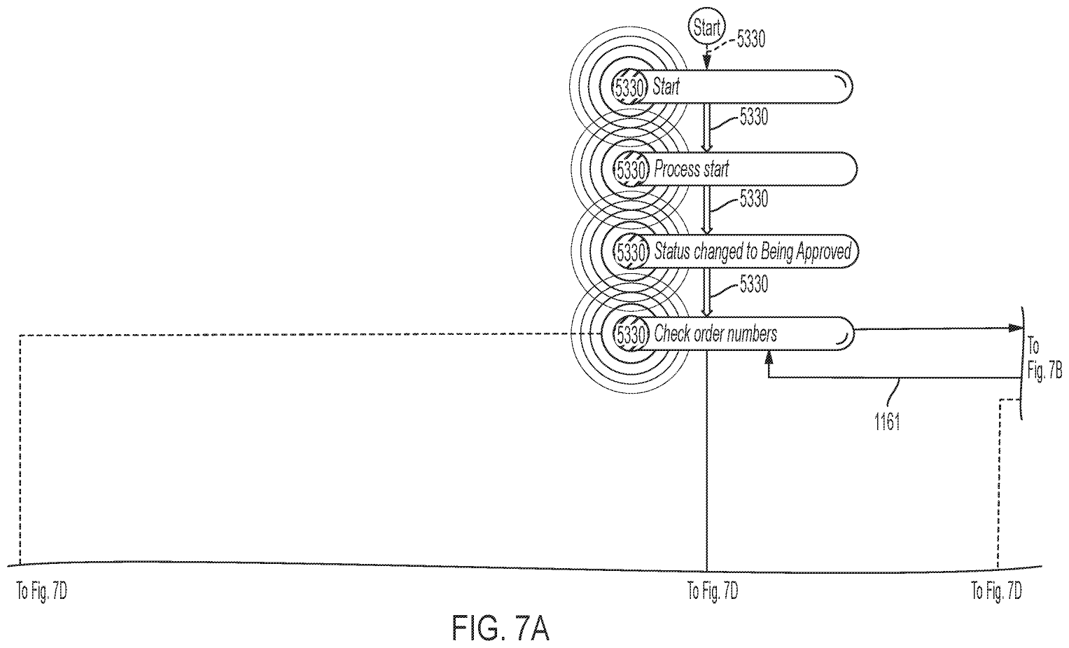

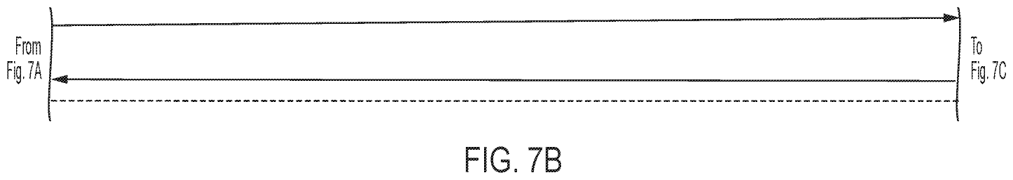

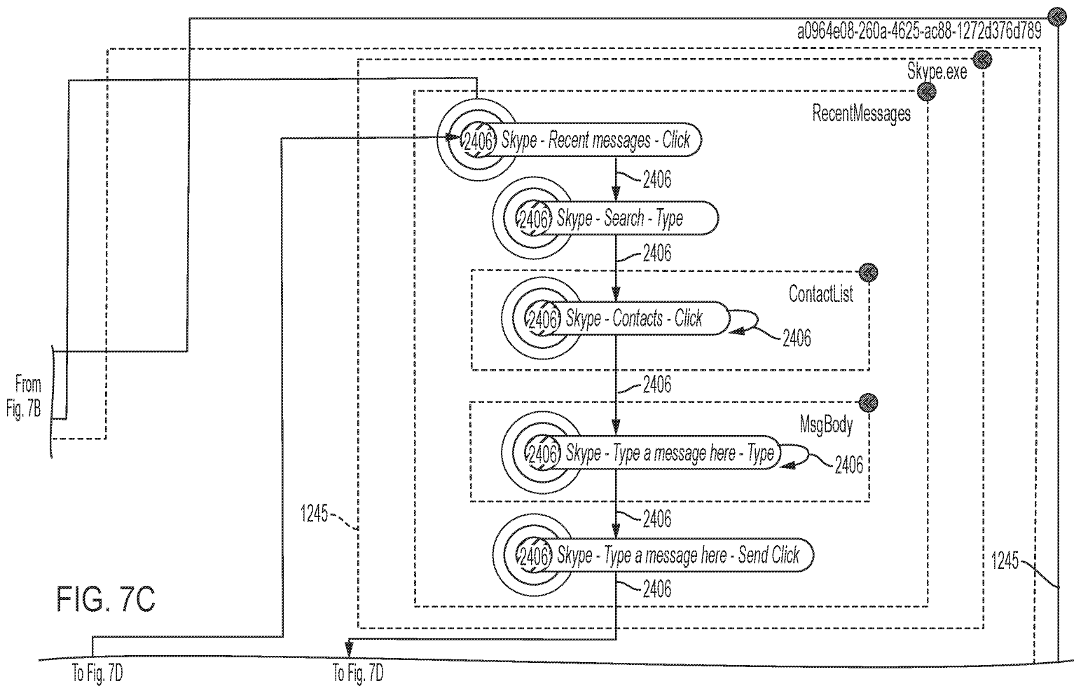

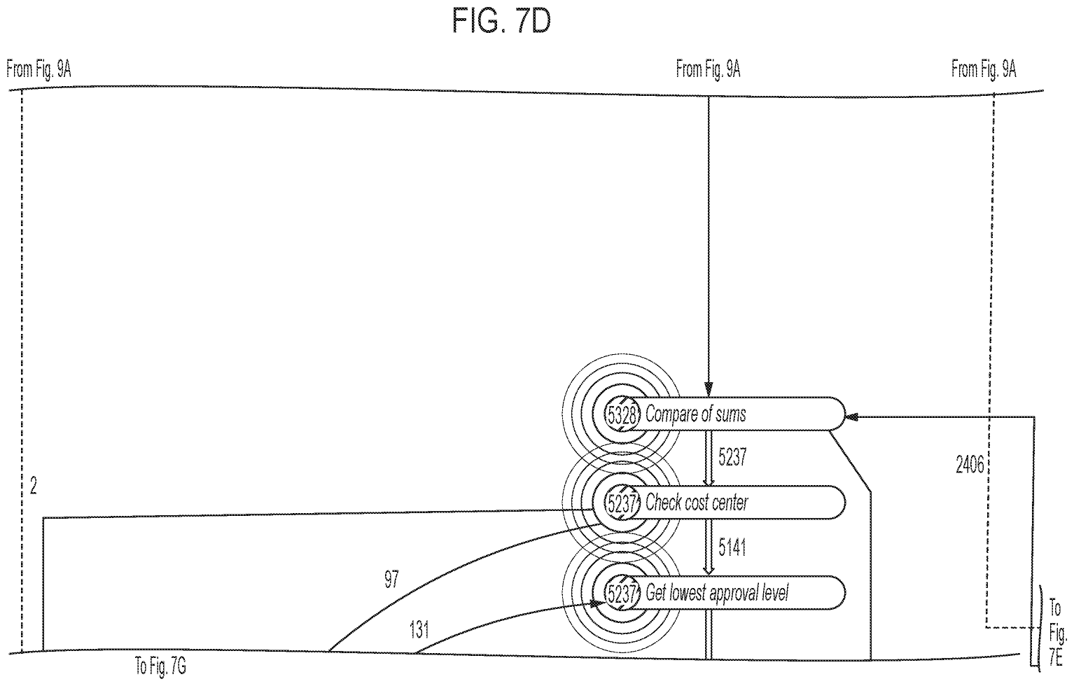

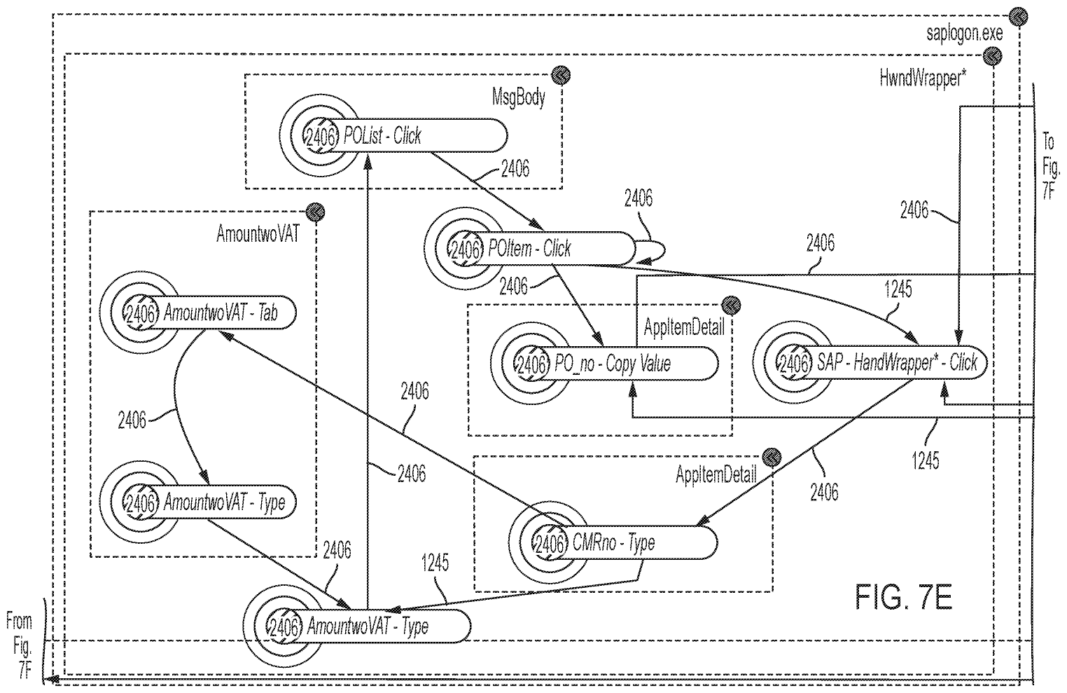

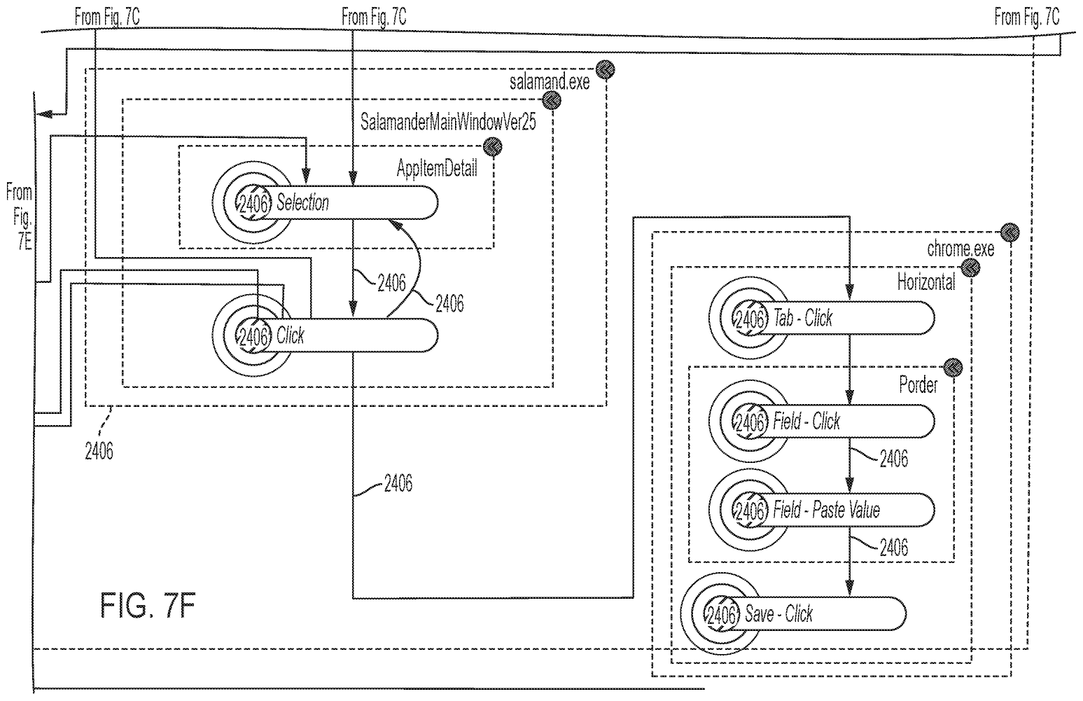

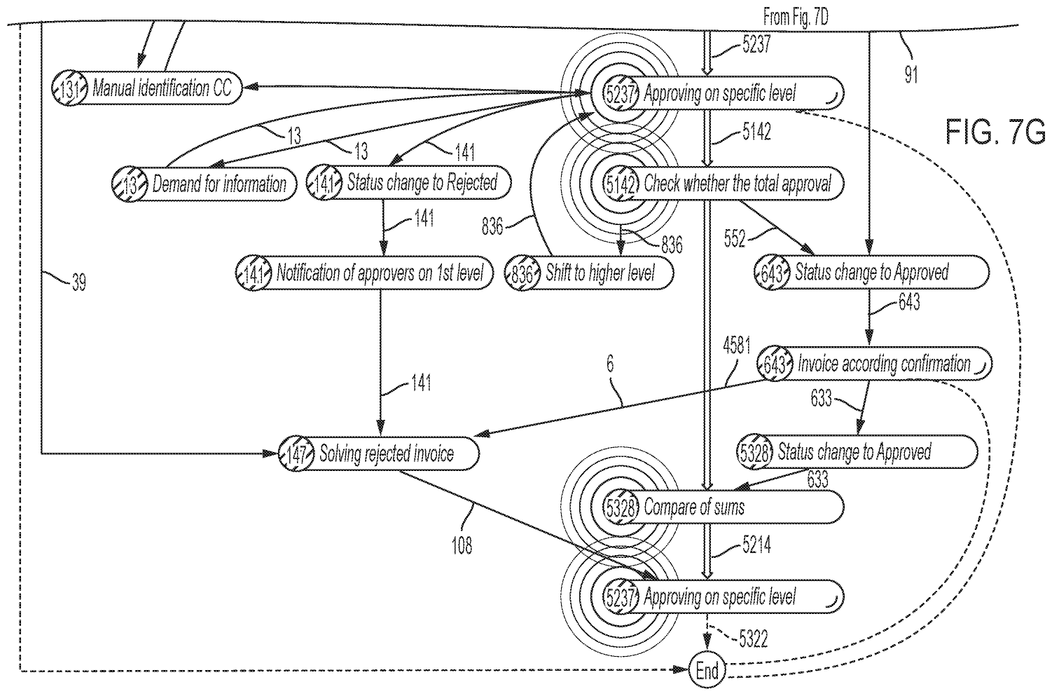

Referring to FIG. 7, a process map with an expanded hierarchy is disclosed according to one embodiment. FIG. 7 illustrates the hierarchical part of a high granularity eventlog inserted into a low granularity business process model with the all parts of the hierarchy expanded to lowest level (e.g., additional “drill down”). Thus, this illustrates a multi-level process view with combined low and high granularity expanded to maximum detail.

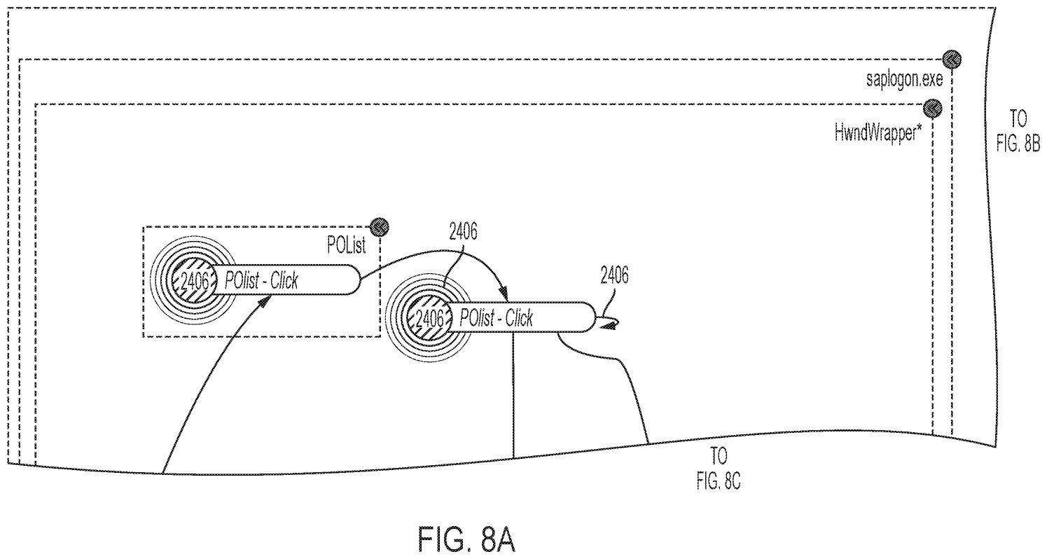

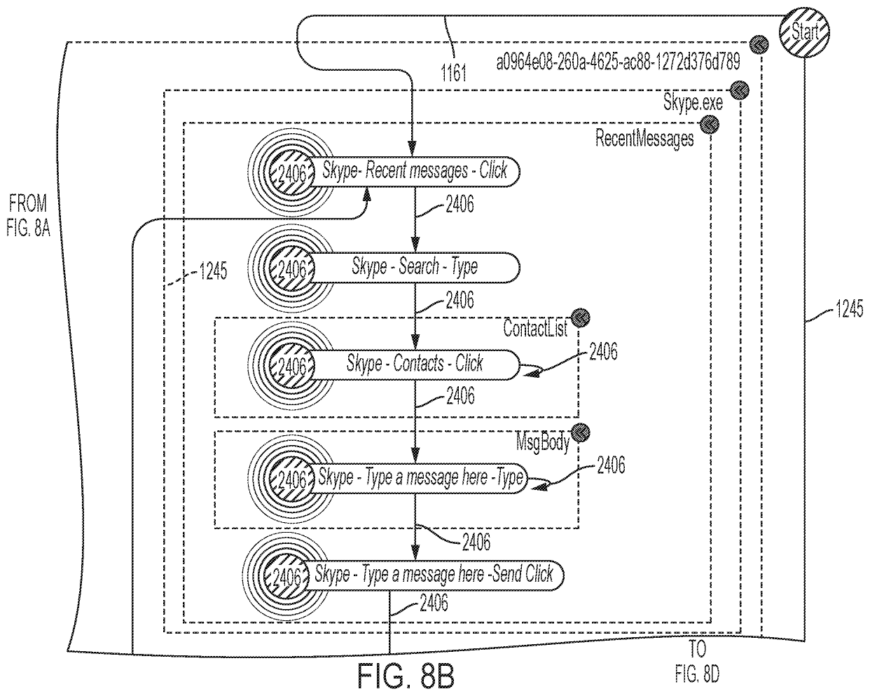

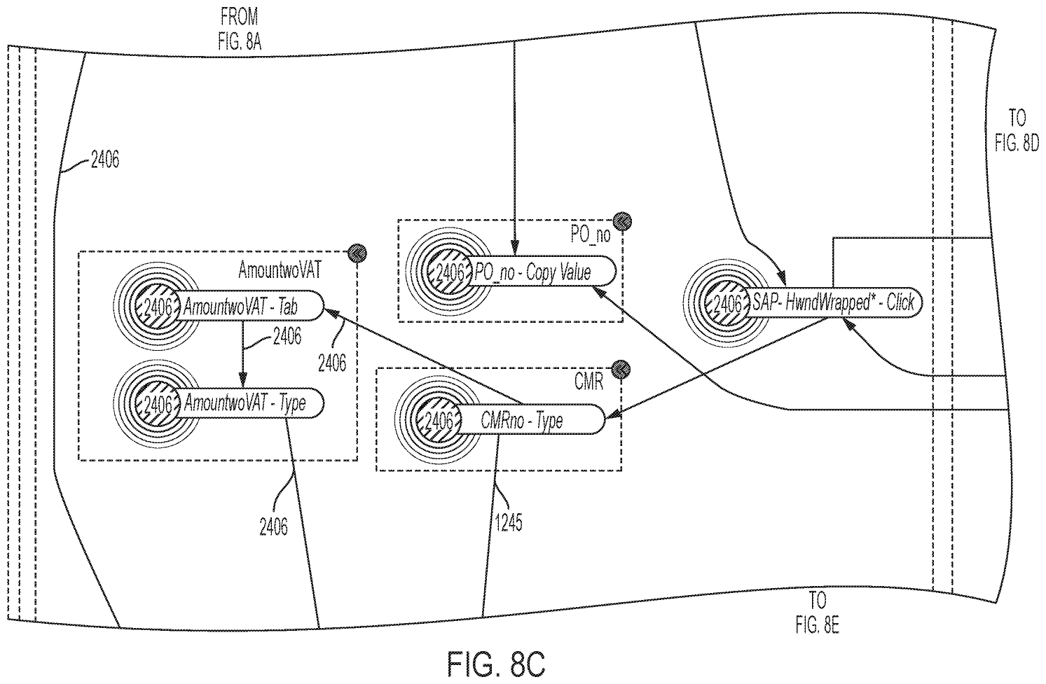

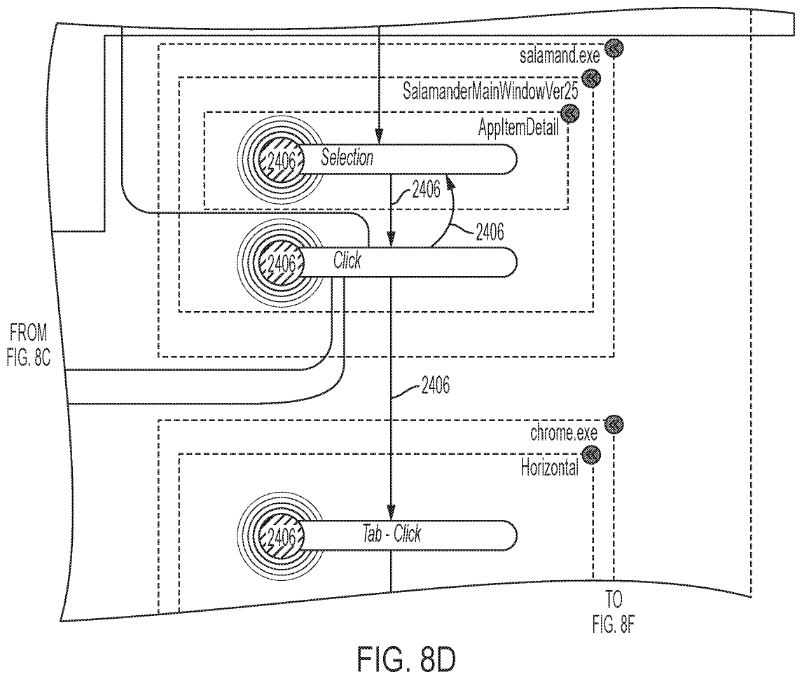

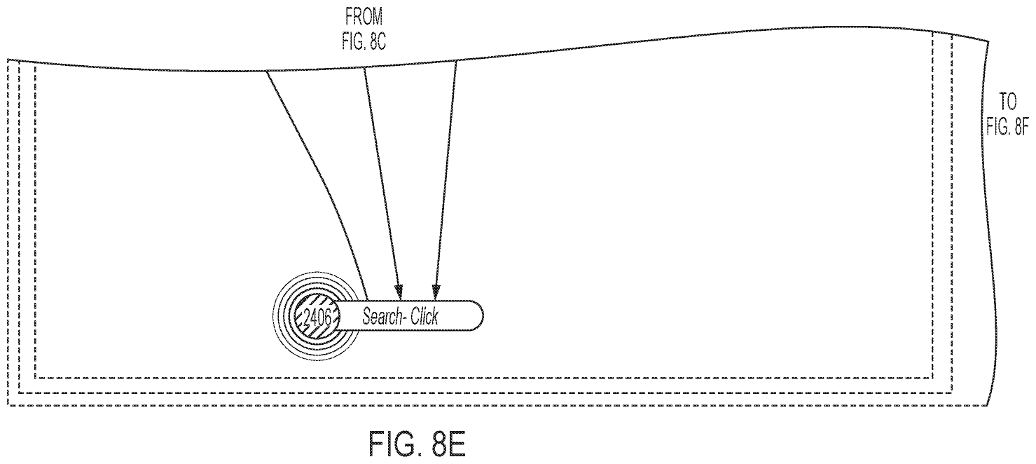

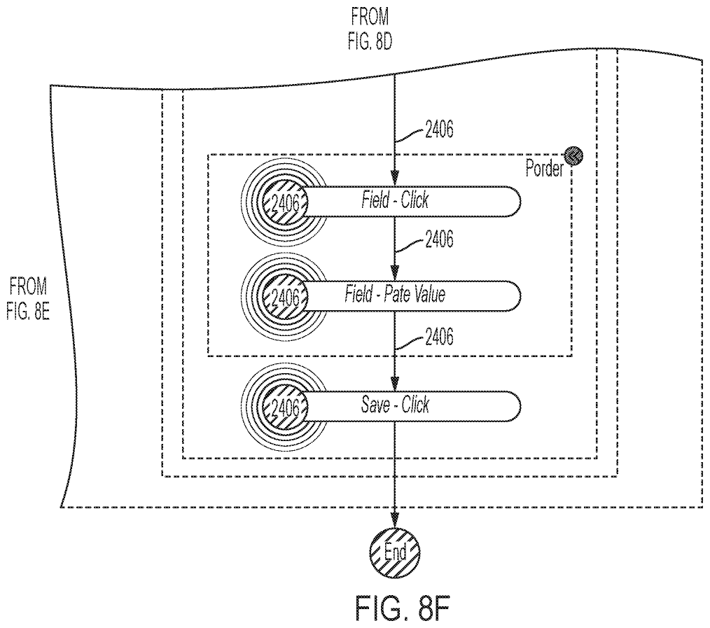

Referring to FIG. 8, a process map with expanded hierarchy details is disclosed according to one embodiment. FIG. 8 illustrates the filtered hierarchical process map fully expanded to the highest possible detail.

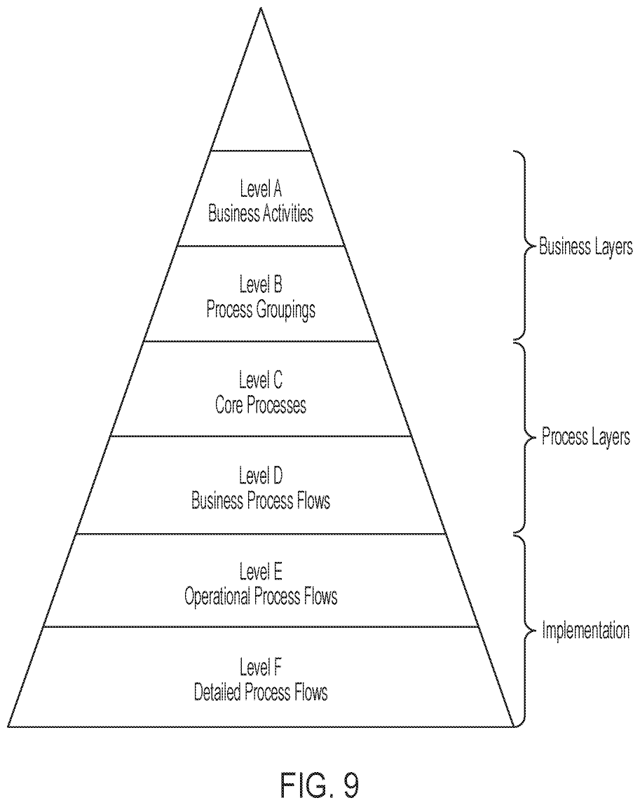

FIG. 9 depicts an exemplary business process management (BPM) use case hierarchy according to one embodiment. The BPM hierarchy may vary from organization to organization. For example, the hierarchy may include an identification of business activities, process groupings, core processes, business process flows, operational process flows, and detailed process flows.

In one embodiment business layers may include business activities (Level A) and process groupings (Level B). Business activities may include business activities for the business, and process groupings may include, for example, value domains, business functions, end-to-end processes, service streams, process line streams, enabling streams, etc.

Process layers may include core processes (Level C) and business process flows (Level D). Core processes may include core processes for the business, and business process flows may include processes at the task level.

Implementation may include operational process flows (Level E) and detailed process flows (Level F). Operational process flows may include sub-processes at the steps level, and resource requirements. Detailed process flows may include detailed processes at the operational level, and detailed resource requirements.

Embodiments may facilitate the view of a BPM by navigating the hierarchy (e.g., levels A-F) and viewing details at each level within the hierarchy.

It will be appreciated by persons skilled in the art that the present invention is not limited by what has been particularly shown and described hereinabove. Rather the scope of the present invention includes both combinations and sub-combinations of features described hereinabove and variations and modifications thereof which are not in the prior art. It should further be recognized that these embodiments are not exclusive to each other.

It will be readily understood by those persons skilled in the art that the embodiments disclosed here are susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for hierarchical process mining comprising:
in an information processing apparatus comprising at least one computer processor:
collecting, from a data source, data comprising a plurality of attributes;
correlating the data;
creating a hierarchy of the correlated data by clustering the correlated data;
validating the hierarchy by verifying that each sub-value in the hierarchy fits into a higher level of the hierarchy;
processing the corelated data with a process mining algorithm to identify a process model;
combining the validated hierarchy with the identified process model; and
graphically presenting the hierarchy in an interactive manner, wherein the hierarchy may be interacted with by moving up or down in the hierarchy.

2. The method of claim 1, wherein the data comprises a data log, and each column in the data log is an attribute.

3. The method of claim 1, wherein each attribute is a level in the hierarchy.

4. The method of claim 1, wherein the data is received as a plurality of data structures that are linked by a correlation indicator or foreign key.

5. The method of claim 1, wherein the data is received from an event log merge.

6. The method of claim 1, wherein the data is correlated using a data correlation algorithm.

7. The method of claim 1, wherein the data is correlated based on a timestamp.

8. The method of claim 1, wherein the data is correlated based on a process or event identifier.

9. The method of claim 1, wherein the data is correlated based on a human or system resource.

10. The method of claim 1, wherein the data is correlated based on an application.

11. A system for hierarchical process mining comprising:
a plurality of data sources;
a user electronic device comprising a display; and
a server comprising at least one computer processor;
wherein a computer program or application executed by the server performs the following:
collects data comprising a plurality of attributes from the plurality of data sources;
correlates the data;
creates a hierarchy of the correlated data by clustering the correlated data;
validates the hierarchy by verifying that each sub-value in the hierarchy fits into a higher level of the hierarchy;
processes the corelated data with a process mining algorithm to identify a process model;
combines the validated hierarchy with the identified process model; and
graphically presents the hierarchy on the display in an interactive manner, wherein the hierarchy may be interacted with by moving up or down in the hierarchy.

12. The system of claim 11, wherein the data comprises a data log, and each column in the data log is an attribute.

13. The system of claim 11, wherein each attribute is a level in the hierarchy.

14. The system of claim 11, wherein the data is received as a plurality of data structures that are linked by a correlation indicator or foreign key.

15. The system of claim 11, wherein the data is received from an event log merge.

16. The system of claim 11, wherein the data is correlated using a data correlation algorithm.

17. The system of claim 11, wherein the data is correlated based on a timestamp.

18. The system of claim 11, wherein the data is correlated based on a process or event identifier.

19. The system of claim 11, wherein the data is correlated based on a human or system resource.

20. The system of claim 11, wherein the data is correlated based on an application.
